(19) United States
(12) Patent Application Publication
(10) Pub. No.: US 2011/0234887 A1
(43) Pub. Date: Sep. 29, 2011

(54) IMAGE CAPTURE DEVICE

(75) Inventors: Takeshi SHIMOHATA, Osaka (JP); Motonori OGURA, Osaka (JP)

(73) Assignee: PANASONIC CORPORATION, Osaka (JP)

(21) Appl. No.: 13/070,073

(22) Filed: Mar. 23, 2011

(30) Foreign Application Priority Data
Mar. 25, 2010 (JP) 2010-069599

(51) Int. Cl. G03B 13/32

(52) U.S. Cl. 348/353; 348/357; 348/E05.024

(57) ABSTRACT

The present invention provides an image capture device that can cut down power dissipation and reduce noise at the same time. The image capture device includes: an imager; at least one lens for producing a subject image on the imager; an actuator for driving the at least one lens in accordance with a control signal; and a driver for outputting the control signal. The driver changes, according to a condition of a subject being shot, the control signals to output from an analog control signal into a digital control signal, or vice versa.

### BACKGROUND OF THE INVENTION

1. Field of the Invention

The present invention relates to an image capture device and more particularly relates to an image capture device for controlling the position of a lens by driving an actuator using a control signal.

2. Description of the Related Art

Japanese Patent Application Laid-Open Publication No. 8-329489 discloses a focus controller for use in an optical pickup circuit for an optical read/write drive. That focus controller can be used in common to perform a focus search operation and a focus servo operation and is driven with pulse width modulation (PWM). And to get these operations done, a controller is provided, which generates a drive signal not every PWM period but only every several periods.

Then, even with the PWM drive, an objective lens can also be moved in fine steps, and both the focus search and focus servo operations can get done using the same pieces of hardware. Consequently, the power to be dissipated by the circuit, and eventually the overall cost, can be cut down.

The PWM control certainly contributes greatly to power-saving but would cause non-negligible noise, which is a problem. Specifically, in a situation where a drive coil or a motor is driven by performing the PWM control, the coil or motor will cause self-induction while the PWM control is in OFF state, thereby generating counter electromotive force, which will then affect another signal as a sort of switching noise or drive noise. As a result, the originally intended signal waveform is so disturbed that the signal quality deteriorates significantly.

And Japanese Patent Application Laid-Open Publication No. 8-329489 pays no attention to such a kind of noise to be generated by performing the PWM drive.

However, such switching noise is a non-negligible problem with recent image capture devices. This is because as the number of pixels of an imager has increased by leaps and bounds these days, each imager now has a much smaller photosensitive area, and would cause a far lower signal-to-noise ratio, than what used to be some time ago. And that noise would affect the quality particularly significantly if a photo of a subject should be shot under bad conditions (e.g., in a dark environment with an insufficient amount of light).

### SUMMARY OF THE INVENTION

It is therefore an object of the present invention to provide an image capture device that can cut down power dissipation and reduce such noise at the same time.

An image capture device according to a preferred embodiment of the present invention includes: an imager; at least one lens for producing a subject image on the imager; an actuator for driving the at least one lens in accordance with a control signal; and a driver for outputting the control signal. The driver changes, according to a condition of a subject being shot, the control signals to output from an analog control signal into a digital control signal, or vice versa.

The subject's condition may concern brightness of the image shot. And the driver may output the digital control signal if the brightness of the image shot is equal to or greater than a predetermined value and may output the analog control signal if the brightness is less than the predetermined value.

The subject's condition may concern predefined high-frequency components to the image shot. And the driver may output the analog control signal if amount of the predefined high-frequency components to the image shot is equal to or greater than a predetermined value and may output the digital control signal if the amount of the predefined high-frequency components is less than the predetermined value.

The subject's condition may concern contrast of the image shot. And the driver may output the digital control signal if the contrast of the image shot is equal to or greater than a predetermined value and may output the analog control signal if the contrast is less than the predetermined value.

The driver may include a first circuit for outputting a pulse wave signal, a second circuit for outputting a non-pulse wave signal, and at least one switch to be turned in order to use either the pulse wave signal or the non-pulse wave signal selectively. The driver may turn the at least one switch according to the condition of the subject being shot. If the pulse wave signal supplied from the first circuit is used, the driver may generate the digital signal based on the pulse wave signal. On the other hand, if the non-pulse wave signal supplied from the second circuit is used, the driver may generate the analog signal based on the non-pulse wave signal.

The second circuit may generate the non-pulse wave signal based on the pulse wave signal supplied from the first circuit.

The at least one lens may include one of a zoom lens for zooming in on, or out, the subject image on the imager, an OIS lens for reducing a blur of the subject image, and a focus lens for controlling the focal length to the subject.

In an image capture device according to a preferred embodiment of the present invention, a driver for outputting a control signal to an actuator changes, according to a condition of a subject being shot, the control signals to output from an analog control signal into a digital control signal, or vice versa. When the digital control signal is used, the power dissipation can be cut down. And when the analog control signal is used, the noise can be reduced. Consequently, this image capture device can cut down the power dissipation and reduce the noise at the same time.

### BRIEF DESCRIPTION OF THE DRAWINGS

FIG. 1 is a block diagram illustrating a configuration for a digital camcorder 100 as a preferred embodiment of the present invention.

FIG. 2 illustrates an exemplary configuration for a focus actuator 290.

FIG. 3 is a block diagram illustrating a specific configuration for a focus driver 300.

FIG. 4 is a flowchart showing the procedure of the processing performed by the focus driver 300 in order to drive a focus lens 170.

FIG. 5A shows the waveform of an analog control signal that has been output by the focus driver 300.

FIG. 5B shows the waveform of a digital control signal that has been output by the focus driver 300.

FIG. 6 is a block diagram illustrating a specific configuration for a focus driver 300 according to a modified example of the present invention.

### DETAILED DESCRIPTION OF PREFERRED EMBODIMENTS

Hereinafter, preferred embodiments of an image capture device according to the present invention will be described with reference to the accompanying drawings. In the following description, the image capture device of the present invention is supposed to be a digital camcorder as an example.

[1. Configuration for Digital Camcorder]

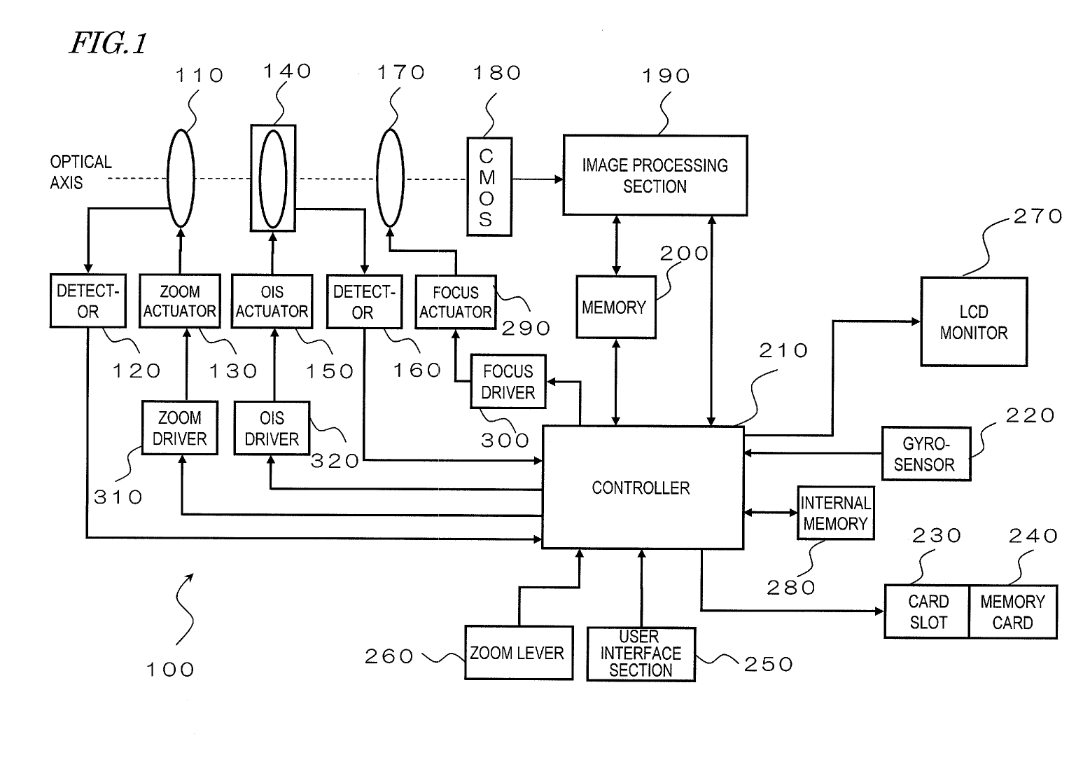

Hereinafter, the electrical configuration of a digital camcorder 100 as a specific preferred embodiment of the present invention will be described with reference to FIG. 1.

FIG. 1 is a block diagram illustrating a configuration for the digital camcorder 100. This digital camcorder 100 is designed to make a CMOS image sensor 180 (which will be sometimes simply referred to herein as an “imager”) capture a subject image that has been produced by an optical system including a zoom lens 110. The video data that has been generated by the CMOS image sensor 180 is subjected by an image processing section 190 to various kinds of processing and then stored in a memory card 240. If necessary, the video data stored in the memory card 240 can be displayed on an LCD monitor 270.

In this preferred embodiment, the digital camcorder 100, changes, based on a condition of the subject being shot (such as the brightness of an image shot), the control signals to supply to a lens actuator for controlling the position of a focus lens 170 from an analog control signal into a digital control signal, or vice versa. For example, if the brightness of the image shot is equal to or greater than a predetermined level, the influence of noise, if any, would be so limited that the digital camcorder 100 changes the control signals into a digital control signal to perform a PWM control. On the other hand, if the brightness of the image shot is smaller than the predetermined level, the influence of the noise would grow so much that the digital camcorder 100 changes the control signals from the digital control signal into an analog control signal. By changing the control signals from the digital control signal into the analog control signal, or vice versa, according to the subject's condition in this manner, power dissipation can be cut down and the noise can be reduced at the same time.

Hereinafter, the configuration of this digital camcorder 100 will be described in further detail.

The optical system of this digital camcorder 100 is made up of the zoom lens 110, an optical image stabilizer (OIS) 140, and a focus lens 170. The zoom lens 110 is driven by a zoom actuator 130 to move along the optical axis of the optical system and thereby zoom in on, or out, the subject image. The focus lens 170 is driven by a focus actuator 290 to move along the optical axis of the optical system, thereby adjusting the focal length to the subject.

The OIS 140 includes a stabilizer lens that can move internally within a plane that intersects with the optical axis at right angles. Specifically, in the OIS 140, the stabilizer lens is driven by an OIS actuator 150 in such a direction as to cancel the shake of the digital camcorder 100, thereby stabilizing the subject image.

The zoom actuator 130 drives the zoom lens 110 in accordance with a control signal supplied from the zoom driver 310. The zoom motor 130 may be implemented as a pulse motor, a DC motor, a linear motor or a servo motor, for example. If necessary, the zoom motor 130 may drive the zoom lens 110 via a cam mechanism, a ball screw, or any other appropriate mechanism. A detector 120 detects the position of the zoom lens 110 on the optical axis. As the zoom lens 110 moves in the optical axis direction, the detector 120 outputs a signal representing the position of the zoom lens through a switch such as a brush.

In accordance with the control signal supplied from the OIS driver 320, the OIS actuator 150 drives the stabilizer lens in the OIS 140 within a plane that intersects with the optical axis at right angles. The OIS actuator 150 may be implemented as a planar coil or an ultrasonic motor. A detector 160 senses how much the stabilizer lens has moved in the OIS 140.

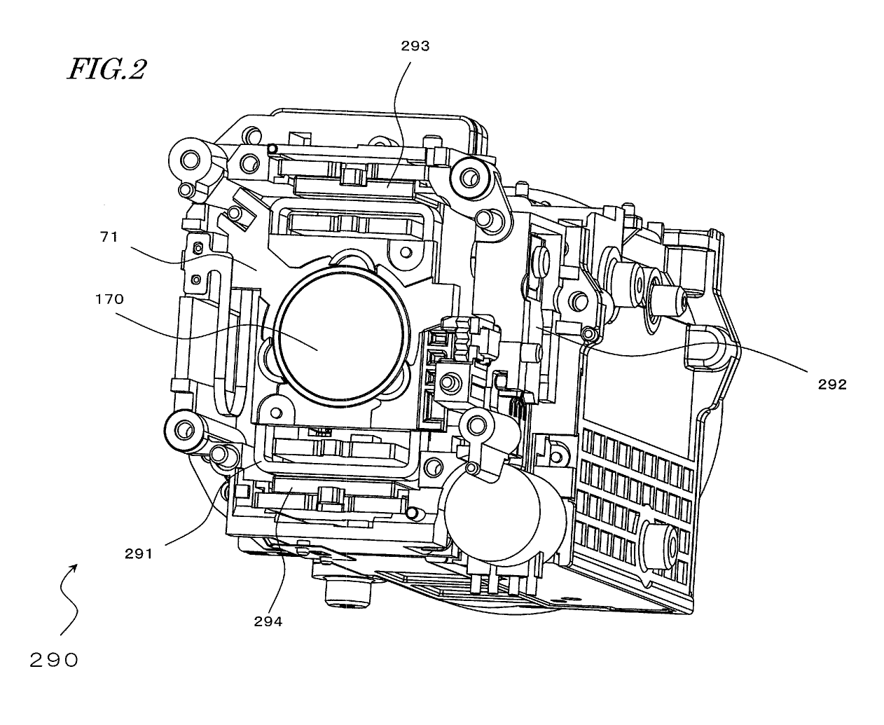

FIG. 2 illustrates an exemplary configuration for the focus actuator 290, which may be arranged in the lens barrel of the digital camcorder 100, for example. In FIG. 2, the focus lens 170, as well as the focus actuator 290, is also shown. The focus lens 170 is secured to a movable frame 71, which is usually obtained by forming a resin material.

The focus actuator 290 includes a drive coil 291, a position sensor 292, and driving magnets 293 and 294. In this preferred embodiment, the position sensor 292 is provided to detect the position of the focus lens and is made up of a magnetoresistive (MR) transducer and a quadrangular prism magnet, which is magnetized at a very small pitch. A CMOS image sensor 180 is actually attached so as to face the focus lens 170 with a narrow space left between them, but is not shown in FIG. 2.

FIG. 1 is referred to again.

The CMOS image sensor 180 captures the subject image, which has been produced by the optical system including the zoom lens 110, thereby generating video data. The CMOS image sensor 180 performs exposure, transfer, electronic shuttering and various other kinds of operations.

The image processing section 190 subjects the video data that has been generated by the CMOS image sensor 180 to various kinds of processing. For example, the image processing section 190 processes the video data that has been generated by the CMOS image sensor 180, thereby generating either video data to be displayed on the LCD monitor 270 or video data to be stored back into the memory card 240 again. The image processing section 190 may also subject the video data that has been generated by the CMOS image sensor 180 to gamma correction, white balance correction, flaw correction and various other sorts of processing. Furthermore, the image processing section 190 also compresses the video data that has been generated by the CMOS image sensor 180 in a compression format compliant with the H. 264 standard or the MPEG-2 standard. The image processing section 190 may be implemented as a DSP or a microcomputer.

The controller 210 performs an overall control on all of these components of the digital camcorder 100. The controller 210 may be implemented as a semiconductor device, for example, but could also be implemented as either only a single piece of hardware or a combination of hardware and software. For example, the controller 210 could be a microcomputer.

A memory 200 functions as a work memory for the image processing section 190 and the controller 210, and may be implemented as a DRAM or a ferroelectric memory, for example.

The LCD monitor 270 can display an image represented by the video data that has been generated by the CMOS image sensor 180 and an image represented by the video data that has been retrieved from the memory card 240.

The gyrosensor 220 may be implemented as a kind of vibrating member such as a piezoelectric transducer. Specifically, the gyrosensor 220 vibrates the vibrating member such as a piezoelectric transducer at a constant frequency and transforms the Coriolis force produced into a voltage, thereby obtaining angular velocity information. Then, the controller 210 gets the angular velocity information from the gyrosensor 220 and gets the stabilizer lens driven in the OIS in such a direction that will cancel that shake. As a result, the shake of the digital camcorder 100 that has been generated by the user's hand or body tremors can be canceled.

The memory card 240 can be readily inserted into, or removed from, this digital camcorder 100 through a card slot 230, which is connectible both mechanically and electrically to the memory card 240. The memory card 240 includes a flash memory or a ferroelectric memory inside, and can store data.

An internal memory 280 may be a flash memory or a ferroelectric memory, for example, and stores a control program for performing an overall control on this digital camcorder 100.

A user interface section 250 is a member for accepting the user's instruction to capture an image. A zoom lever 260 is a member for accepting the user's instruction to change the zoom power.

[2. Detailed Configuration of Focus Driver]

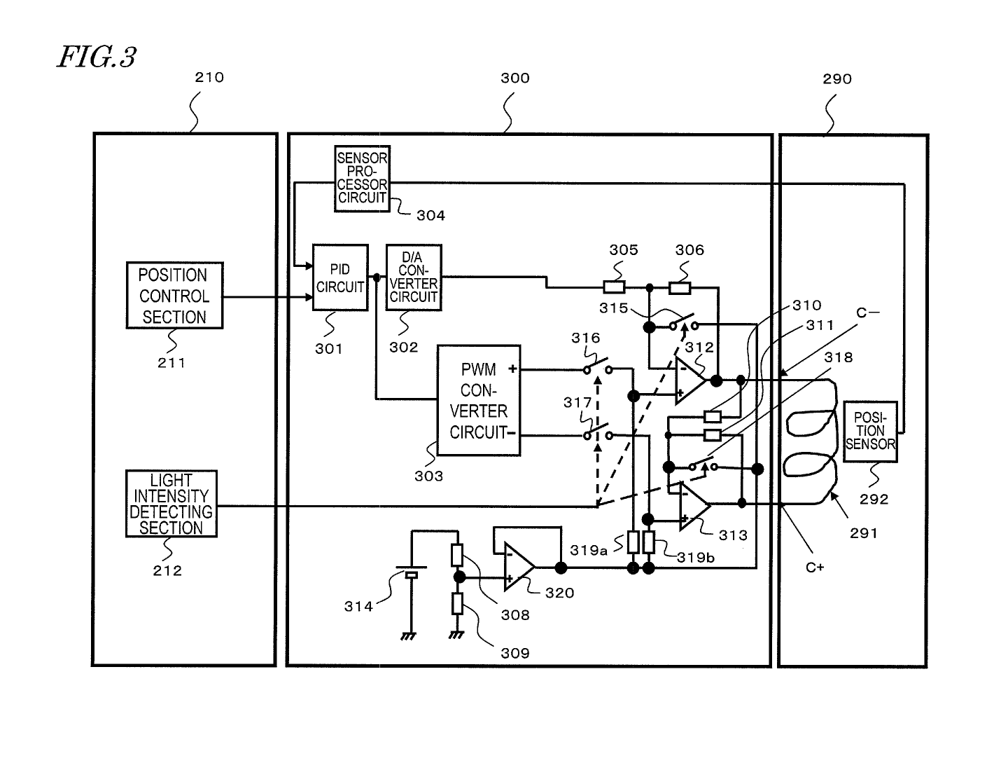

Next, the detailed structure of the focus driver 300 will be described with reference to FIG. 3, which is a block diagram illustrating a specific configuration for the focus driver 300.

Now let us make reference to FIG. 3 first.

In FIG. 3, illustrated are not only the focus driver 300 but also the controller 210 and the focus actuator 290 as well in order to indicate the flow of control signals.

The controller 210 has a number of functional blocks. Among those blocks, shown in FIG. 3 are a position control section 211 for calculating the position of the focus lens at which the subject video comes into focus and a light intensity detecting section 212 for detecting the brightness of the image captured (i.e., the intensity of the light that has been reflected from the subject). On the other hand, the focus actuator 290 includes a drive coil 291 for driving the focus lens 170 and a position sensor 292 for detecting the position of the focus lens 170.

Next, the specific configuration of the focus driver 300 will be described. The focus driver 300 includes a PID circuit 301, a D/A converter circuit 302, a PWM converter circuit 303, a sensor processor circuit 304 and various other circuit components. The sensor processor circuit 304 transforms the signal supplied from the position sensor 292 into digital position information. The PID circuit 301 performs proportionality, integration and differentiation operations on a differential signal representing the difference between the signals supplied from the position control section 211 and the sensor processor circuit 304 by digital processing.

The D/A converter circuit 302 converts the digital output signal of the PID circuit 301 into an analog signal. The PWM converter circuit 303 converts the digital output signal of the PID circuit 301 into a two-phase PWM signal.

Those various other circuit components of the focus driver 300 include resistors 305, 306, 310, 311, 319a and 319b, power op amps 312 and 313, a power supply 314, an op amp 320 and switches 315 to 318.

The power op amps 312 and 313 can output relatively large amounts of current. The resistors 305 and 306 have the same relatively high resistance value. Specifically, the resistor 305 is connected to the output terminal of the D/A converter circuit 302 and to the inverting input terminal of the power op amp 312. On the other hand, the resistor 306 is connected between the inverting input terminal and output terminal of the power op amp 312. These resistors 305 and 306 and the power op amp circuit 312 together form an inverting amplifier with a 1× gain.

The resistors 310 and 311 have the same relatively high resistance value. Specifically, the resistor 310 is connected between the output terminal of the power op amp 312 and the inverting input terminal of the power op amp 313. On the other hand, the resistor 311 is connected between the inverting input terminal and output terminal of the power op amp 313. These resistors 310 and 311 and the power op amp circuit 313 together form an inverting amplifier with a lx gain.

Likewise, the resistors 319a and 319b also have the same relatively high resistance value. The op amp 320 is a voltage follower circuit, of which the inverting input terminal and output terminal are connected together. These resistors 319a and 319b and the op amp 320 together form a reference voltage source, which outputs a voltage that is a half as high as the supply voltage of the power supply 314.

The output terminal of the op amp 320 is connected to the respective non-inverting input terminals of the power op amps 312 and 313 by way of the resistors 319a and 319b with the relatively high resistance value.

Using its output signal, the light intensity detecting section 212 controls the opened or closed states of the switches 315 to 318. Specifically, the switch 315 is connected between the non-inverting input terminal of the op amp 312 and the output terminal of the op amp 320. The switch 316 is connected between the positive direction output terminal of the PWM converter circuit 303 and the non-inverting input terminal of the power op amp 312. The switch 317 is connected between the negative direction output terminal of the PWM converter circuit 303 and the non-inverting input terminal of the power op amp 313. And the switch 318 is connected between the non-inverting input terminal of the op amp 312 and the output terminal of the op amp 320.

[3. Focus Lens Driving Operation]

Next, it will be described with reference to FIGS. 3 through 5B how to drive the focus lens 170 in this digital camcorder 100.

In this preferred embodiment, the focus driver 300 generates two different types of control signals, namely, a digital control signal and an analog control signal, in order to drive the focus actuator 290. In this description, the digital control signal refers to a pulse wave signal such as a PWM signal, while the analog control signal refers to a non-pulse wave signal other than the digital control signal. For example, control signals such as a DC signal and a quasi-DC signal are analog control signals.

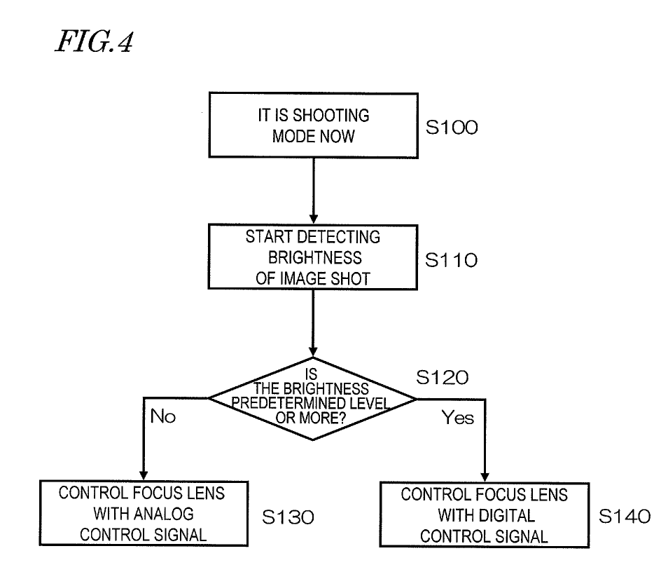

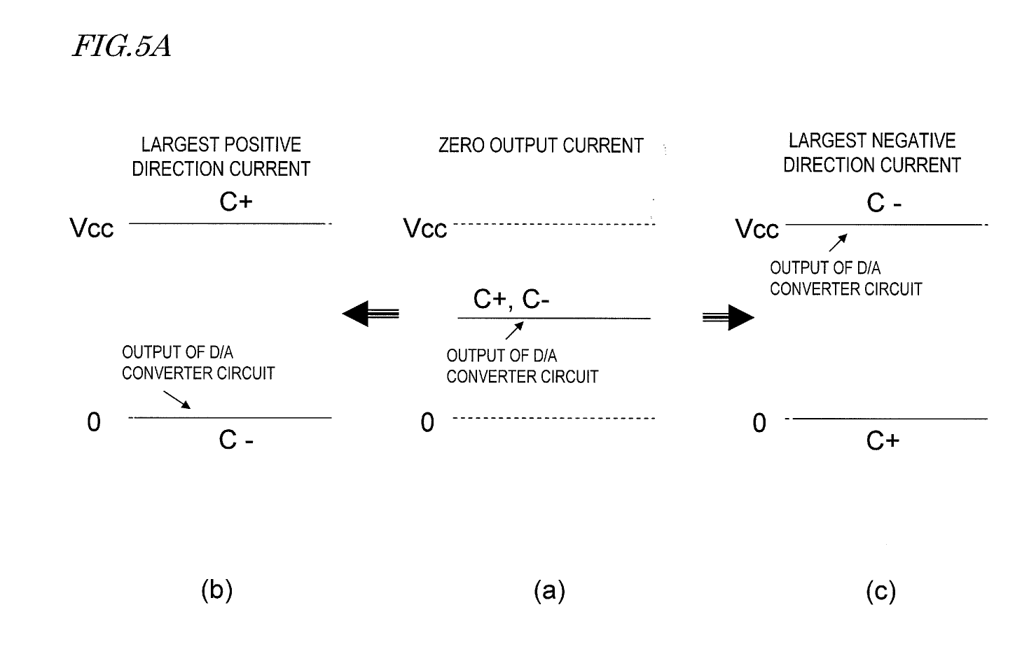

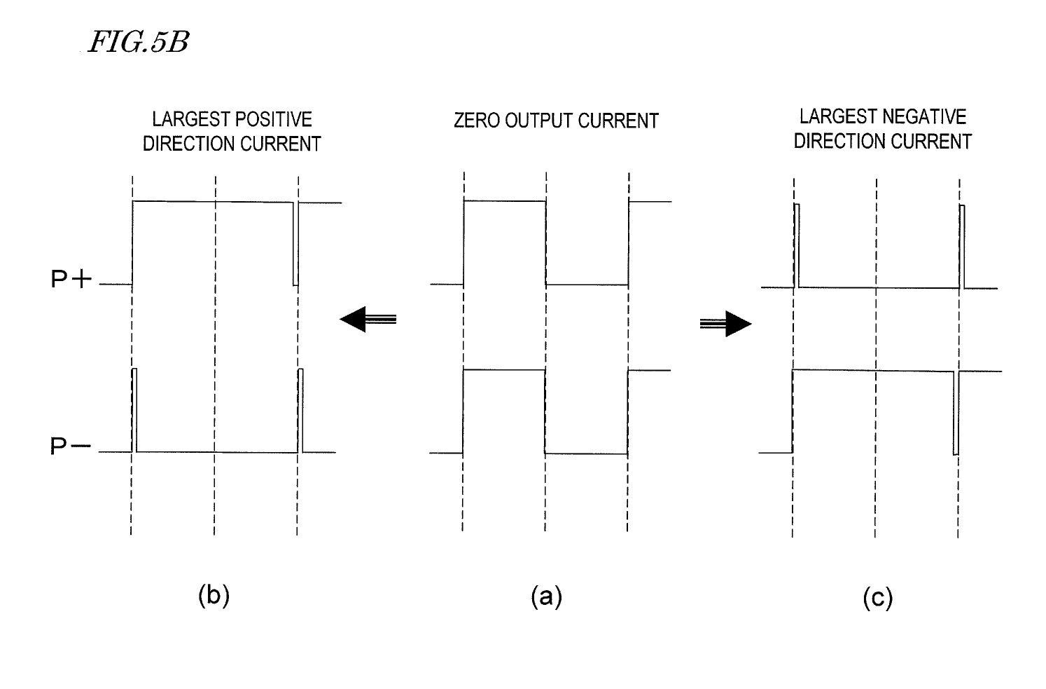

FIG. 4 is a flowchart showing the procedure of the processing performed by the focus driver 300 in order to drive the focus lens 170. FIG. 5A shows the waveform of the analog control signal that has been output by the focus driver 300, while FIG. 5B shows the waveform of the digital control signal that has been output by the focus driver 300.

When the power switch of this digital camcorder 100 is turned ON, the controller 210 determines, for a start, whether the current mode of operation of this digital camcorder 100 is a shooting mode or a playback mode. The focus lens driving operation of this preferred embodiment is carried out in the shooting mode. That is why the following description is based on the supposition that the current mode of operation has turned out to be the shooting mode in Step S100.

Next, in Step S110, the light intensity detecting section 212 of the controller 210 (see FIG. 3) detects the brightness of the image shot (i.e., the intensity of the light that has been reflected from the subject being shot). In this processing step, the light intensity may be detected based on either the average of the output signals of the imager or the output signal of photosensors (not shown).

Subsequently, in Step S120, the light intensity detecting section 212 determines whether or not the brightness of the image shot is equal to or greater than, or less than, a predetermined level.

If the brightness turns out to be less than the predetermined level, the process advances to Step S130. In that case, the focus driver 300 sends the analog control signal to the focus actuator 290, which controls the position of the focus lens 170 in accordance with the analog control signal (in Step S130). Unless the brightness as a kind of subject's condition is insufficient, it is difficult to ensure a sufficiently high light intensity. In that case, the image would be seriously affected by the noise that has been caused by PWM drive. That is why in such a situation, no PWM drive using the digital control signal is carried out but the focus lens 170 is driven using the analog control signal.

This processing step S130 will be described in further detail.

First of all, the focus driver 300 opens the switches 315, 316, 317 and 318. As a result, the focus driver 300 operates in response to the analog signal supplied from the D/A converter circuit 302. At this point in time, a half of the supply voltage is applied to the respective non-inverting input terminals of the power op amps 312 and 313.

If the output of the D/A converter circuit 302 is a half of the full scale (i.e., a half of the supply voltage), no potential difference will be generated between the two terminals of the coil 291 and the focus lens has a zero drive current. Portion (a) of FIG. 5A shows the waveform of the analog control signal in such a situation where the drive current is zero.

On the other hand, if the output of the D/A converter circuit 302 is minimum (i.e., 0 V), then the highest voltage (which is substantially equal to the supply voltage) is applied to the C+ terminal of the coil 291 and the lowest voltage (i.e., approximately 0 V) is applied to the C− terminal of the coil 291. In this case, the current flows through the coil from the C+ terminal toward the C− terminal thereof (and such current will be referred to herein as “positive direction drive current”). Portion (b) of FIG. 5A shows the waveform of the analog control signal in a situation where the positive direction drive current is maximum.

If the output of the D/A converter circuit 302 is maximum (i.e., as high as the supply voltage), the lowest voltage (of approximately 0 V) is applied to the C+ terminal of the coil and the highest voltage (approximately equal to the supply voltage) is applied to the C− terminal of the coil. In this case, the current flows through the coil from the C− terminal toward the C+ terminal thereof (and such current will be referred to herein as “negative direction drive current”). Portion (c) of FIG. 5A shows the waveform of the analog control signal in a situation where the negative direction drive current is maximum.

In this manner, the focus lens 170 is driven by changing the directions of the coil current flowing through the drive coil 291 from the positive direction into the negative direction, or vice versa, according to the output of the D/A converter circuit 302 with respect to the reference voltage. This coil current functions as an analog control signal that has been supplied from the focus driver 300 to the focus actuator 290.

If the brightness of the image shot turns out to be equal to or greater than the predetermined level in the processing step S120 shown in FIG. 4, the process advances to Step S140. In that case, the focus driver 300 sends the digital control signal to the focus actuator 290, which controls the position of the focus lens 170 in accordance with the digital control signal. If the brightness as a kind of subject's condition is sufficient, a sufficiently high light intensity can be ensured. In that case, the image would be hardly affected by the noise that has been caused by PWM drive. That is why in such a situation, a focus control is carried out using the digital control signal.

Next, this processing step 140 will be described in further detail.

In this processing step, the focus driver 300 closes the switches 315, 316, 317 and 318 to make all of them electrically continuous. As a result, the focus driver 300 operates in response to the PWM signal supplied from the PWM converter circuit 303.

In that case, the P+ output of the PWM converter circuit 303 is connected to the non-inverting input terminal of the power op amp 312, while the P− output of the PWM converter circuit 303 is connected to the inverting input terminal of the power op amp 313. By setting the resistance values of the resistors 318 and 319 to be much higher than the ON-state resistance value of the switches 316 and 317, the pulse signal can be supplied from the PWM converter circuit 303 to the non-inverting input terminal of the power op amp without being distorted.

In the meantime, since the switches 315 and 318 are now electrically continuous with each other, the output pulse signal of the PWM converter circuit 303 is also supplied to the output of the op amp 320, which is connected to the respective inverting input terminals of the op amps 312 and 313. As a result, the power op amps 312 and 313 operate as a comparator and the pulse wave that has been received at their non-inverting input terminal is passed to their output terminal. Consequently, the focus actuator 290 can be driven in accordance with the digital control signal using the focus lens and the PWM signal.

Portions (a) through (c) of FIG. 5B illustrate the waveforms of digital control signals output by the focus driver 300. Using this digital control signal, PWM drive can be done with a pulse waveform.

In each of portions (a) to (c) of FIG. 5B, the upper waveform is that of a PWM signal output through the P+ terminal (positive direction) of the PWM converter circuit 303, while the lower waveform is that of a PWM signal output through the P− terminal (negative direction) thereof.

If the output of the PID circuit 301 is a half of the full scale, a PWM signal with a duty of 50% of (2) is output in both of the positive and negative directions. Since the voltage waveforms at both of the two terminals of the drive coil 291 are the same in such a state, no coil current flows. Portion (a) of FIG. 5B illustrates the waveform of the PWM signal in a situation where the output current is zero.

If the output of the PID circuit 301 is maximum, the positive direction output P+ terminal has a maximum duty and the negative direction output P− terminal has a minimum duty. The pulse voltage applied to the drive coil 291 is smoothed with the inductance of the coil, thus making the largest current flow in the positive direction. Portion (b) of FIG. 5B illustrates the waveform of the PWM signal in a situation where the output current is maximum in the positive direction.

If the output of the PID circuit 301 is minimum, the positive direction output P+ terminal has a minimum duty and the positive direction output P− terminal has a maximum duty. As a result, the largest current flows through the drive coil 291 in the negative direction. The focus lens 170 is driven by controlling and changing the flowing directions of the coil current in this manner from the positive direction into the negative direction, or vice versa, using the PWM signal with respect to a half of the full scale output of the PID circuit 301 as a reference level. Portion (c) of FIG. 5B illustrates the waveform of the PWM signal in a situation where the output current is maximum in the negative direction.

According to the PWM drive, high power efficiency can be achieved and power dissipation can be cut down when the coil is driven. However, electromagnetic noise coming from the drive coil could affect the CMOS image sensor 180, which is a problem.

On the other hand, in the case of an analog drive, the power efficiency achieved is low and power dissipation somewhat increases when the coil is driven. Nevertheless, the electromagnetic noise coming from the drive coil to affect the CMOS image sensor 180 can be minimized.

According to the present invention, if the subject is bright enough to avoid generating significant electromagnetic noise with respect to the output of the CMOS image sensor 180, then the PWM drive is adopted. On the other hand, if the subject is too dark to avoid generating significant electromagnetic noise with respect to the output of the CMOS image sensor 180, then the analog drive is adopted. In this manner, the best decision can be made, according to the condition of the subject being shot, on whether the low power dissipation drive or the high image quality under insufficient light should be given a higher priority.

Although the present invention has been described by way of illustrative preferred embodiments, those preferred embodiments are only examples and the present invention is in no way limited to those specific preferred embodiments.

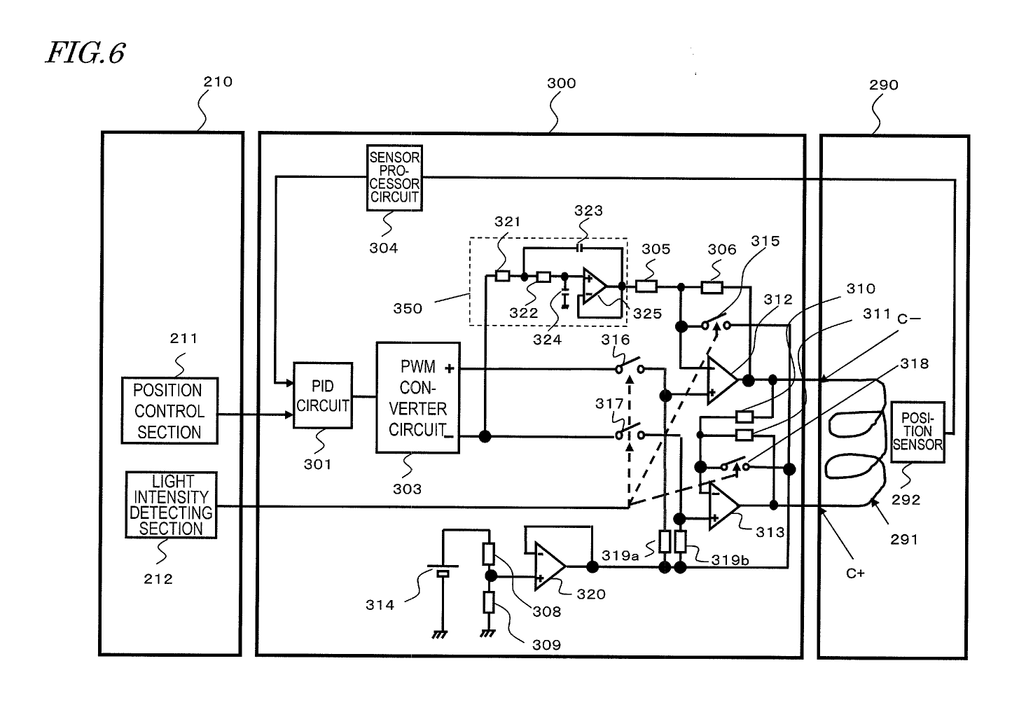

FIG. 6 illustrates a circuit configuration for a focus driver 300 according to a modified example of the present invention. The major difference from the focus driver 300 shown in FIG. 3 is that the D/A converter circuit 302 shown in FIG. 3 is replaced with an active filter circuit 350, which is made up of two resistors 321, 322, two capacitors 322, 323, and one op amp 325. The active filter circuit 350 is connected between the P− output of the PWM converter circuit 303 and the resistor 305.

This active filter circuit 350 can convert the negative direction PWM output of the PWM converter circuit 303 into an analog signal so that the focus actuator 290 can be driven using an analog control signal. The overall operation of the circuit is the same as that of its counterpart shown in FIG. 3. Since the D/A converter circuit can be omitted according to this modified example, the circuit cost of the driver can be more reasonable than in the preferred embodiment shown in FIG. 3.

In the preferred embodiment described above, the control signals to output are supposed to be changed from a digital control signal into an analog control signal, or vice versa, according to the brightness of the image shot as a kind of subject's condition. However, there are other conditions of subject's, too, which include high-frequency components to the image shot and the contrast of the image shot. Hereinafter, these two other conditions will be described specifically.

Such high-frequency components are included a lot in an image shot when the image has a fine pattern, for example. If noise were superposed on such an image, such a fine pattern would lose its details and the apparent image quality would deteriorate. That is why if the high-frequency components to the image shot is equal to or greater than a predetermined reference value, the focus driver 300 may change the control signals to supply to the focus actuator 290 into the analog control signal. On the other hand, if the amount of high-frequency components to the image shot is less than the predetermined reference value, the focus driver 300 may change the control signals to supply to the focus actuator 290 into the digital control signal.

In this description, the “high-frequency components” refer herein to frequency components that are equal to or higher than a predetermined level and that are obtained by subjecting an image shot to high-pass filtering, for example. The high-frequency components may be calculated, and then compared to a reference value, by either the image processing section 190 or the controller 210.

If noise were superposed on an image shot with a low contrast, then the apparent image quality would deteriorate, too. That is why if the average contrast ratio of the entire image shot is smaller than a predetermined reference value, the focus driver 300 may change the control signals to supply to the focus actuator 290 into the analog control signal. On the other hand, if the average contrast ratio is equal to or greater than the predetermined reference value, the focus driver 300 may change the control signals to supply to the zoom actuator 130 into the digital control signal. The average contrast ratio may be calculated, and then compared to a reference value, by either the image processing section 190 or the controller 210.

In the preferred embodiment described above, the focus driver 300 is supposed to change the control signals to supply to the focus actuator from the digital control signal into the analog control signal, or vice versa. However, the control signals to change may also be the ones supplied by the zoom driver 310 to the zoom actuator 130 or the ones supplied by the OIS driver 320 to the OIS actuator 150 as well. Furthermore, only one of the focus driver 300, the zoom driver 310 and the OIS driver 320 may perform the control signal change processing. Or two or more of these three drivers may perform the control signal change processing, too. In any case, these drivers that change the control signals can save power and reduce noise independently of each other.

No specific circuit configurations for the zoom driver 310 or the OIS driver 320 are disclosed in this description or shown in any of the drawings. However, it would be easy for those skilled in the art to design a configuration for changing the control signals from the analog one into the digital one (i.e., PWM signal), or vice versa, by modifying the known configurations of the zoom driver 310 and the OIS driver 320 by reference to the configurations shown in FIGS. 3 and 6.

The optical system and drive system of the digital camcorder 100 of the preferred embodiment shown in FIG. 1 are just examples and do not always have to be used. For example, in the preferred embodiment illustrated in FIG. 1, the optical system is supposed to consist of three groups of lenses. However, the optical system may also consist of any other number of groups of lenses. Furthermore, each of those lenses may be either a single lens or a group of multiple lenses.

Also, in the first preferred embodiment of the present invention described above, the image capturing means is supposed to be the CMOS image sensor 180. However, the present invention is in no way limited to that specific preferred embodiment. Alternatively, the image capturing means may also be a CCD image sensor or an NMOS image sensor.

The present invention is applicable to digital camcorders, digital still cameras and other image capture devices.

1. An image capture device comprising:
an imager;
at least one lens for producing a subject image on the imager;
an actuator for driving the at least one lens in accordance with a control signal; and
a driver for outputting the control signal, the driver changing, according to a condition of a subject being shot, the control signals to output from an analog control signal into a digital control signal, or vice versa.

2. The image capture device of claim 1, wherein the subject's condition concerns brightness of the image shot, and
wherein the driver outputs the digital control signal if the brightness of the image shot is equal to or greater than a predetermined value and outputs the analog control signal if the brightness is less than the predetermined value.

3. The image capture device of claim 1, wherein the subject's condition concerns predefined high-frequency components to the image shot, and
wherein the driver outputs the analog control signal if amount of the predefined high-frequency components to the image shot is equal to or greater than a predetermined value and outputs the digital control signal if the amount of the predefined high-frequency components is less than the predetermined value.

4. The image capture device of claim 1, wherein the subject's condition concerns contrast of the image shot, and
wherein the driver outputs the digital control signal if the contrast of the image shot is equal to or greater than a predetermined value and outputs the analog control signal if the contrast is less than the predetermined value.

5. The image capture device of claim 1, wherein the driver includes
a first circuit for outputting a pulse wave signal,
a second circuit for outputting a non-pulse wave signal, and
at least one switch to be turned in order to use either the pulse wave signal or the non-pulse wave signal selectively,
wherein the driver turns the at least one switch according to the condition of the subject being shot, and
wherein if the pulse wave signal supplied from the first circuit is used, the driver generates the digital signal based on the pulse wave signal, and
if the non-pulse wave signal supplied from the second circuit is used, the driver generates the analog signal based on the non-pulse wave signal.

6. The image capture device of claim 5, wherein the second circuit generates the non-pulse wave signal based on the pulse wave signal supplied from the first circuit.

7. The image capture device of claim 1, wherein the at least one lens includes one of a zoom lens for zooming in on, or out, the subject image on the imager, an OIS lens for reducing a blur of the subject image, and a focus lens for controlling the focal length to the subject.

8. The image capture device of claim 2, wherein the driver includes
a first circuit for outputting a pulse wave signal,
a second circuit for outputting a non-pulse wave signal, and
at least one switch to be turned in order to use either the pulse wave signal or the non-pulse wave signal selectively,
wherein the driver turns the at least one switch according to the condition of the subject being shot, and
wherein if the pulse wave signal supplied from the first circuit is used, the driver generates the digital signal based on the pulse wave signal, and
if the non-pulse wave signal supplied from the second circuit is used, the driver generates the analog signal based on the non-pulse wave signal.

9. The image capture device of claim 3, wherein the driver includes
a first circuit for outputting a pulse wave signal,
a second circuit for outputting a non-pulse wave signal, and
at least one switch to be turned in order to use either the pulse wave signal or the non-pulse wave signal selectively,
wherein the driver turns the at least one switch according to the condition of the subject being shot, and
wherein if the pulse wave signal supplied from the first circuit is used, the driver generates the digital signal based on the pulse wave signal, and
if the non-pulse wave signal supplied from the second circuit is used, the driver generates the analog signal based on the non-pulse wave signal.

10. The image capture device of claim 4, wherein the driver includes
a first circuit for outputting a pulse wave signal,
a second circuit for outputting a non-pulse wave signal, and
at least one switch to be turned in order to use either the pulse wave signal or the non-pulse wave signal selectively,
wherein the driver turns the at least one switch according to the condition of the subject being shot, and
wherein if the pulse wave signal supplied from the first circuit is used, the driver generates the digital signal based on the pulse wave signal, and
if the non-pulse wave signal supplied from the second circuit is used, the driver generates the analog signal based on the non-pulse wave signal.
